(19) United States
(12) Patent Application Publication
(10) Pub. No.: US 2009/0061377 A1
(43) Pub. Date: Mar. 5, 2009

(54) PREFABRICATED ADJUSTABLE IMPLANT-BASED TOOTH MOVEMENT DEVICE

(75) Inventor: Jason B. Cope, Dallas, TX (US)

Correspondence Address: AKIN GUMP STRAUSS HAUER & FELD, LLP, P O BOX 688, DALLAS, TX, 75313-0688, US

(73) Assignee: Under Dog Media, LP, Dallas, TX (US)

(21) Appl. No.: 11/847,485

(22) Filed: Aug. 30, 2007

(51) Int. Cl. A61C 7/00

(52) U.S. Cl. 433/18

(57) ABSTRACT

An adjustable appliance for exerting corrective forces to malpositioned teeth, the appliance comprising a rod member, the rod member having a first anchor attachment portion for securing to an implant, a substantially hollow tubular member defining an inner cavity, the rod member being slidably engaged with the substantially hollow tubular member, and a first force member coupled with the substantially hollow tubular member and at least one tooth of a patient.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A “MICROFICHE APPENDIX”

Not Applicable.

### BACKGROUND OF THE INVENTION

The present invention relates generally to orthodontic appliances. More particularly, the present invention is directed to prefabricated adjustable appliances used for applying corrective forces to malpositioned teeth.

The characteristics of various orthodontic devices and their overall effectiveness during specific types of tooth movement are of major importance for the success of orthodontic treatment and the stability of the patient's end result. There is a long history of specific devices used for certain types of correction. One example of a corrective device is the headgear device which is designed and used to push the maxilla and the maxillary dentition posteriorly, without imparting extrusive or intrusive forces to the teeth.

Many orthodontists have advocated early headgear treatment to guide the growth of the maxilla and to provide certain limited forces to move teeth. Oftentimes the orthodontist's goals are to distalize the maxillary teeth into a correct relationship with the mandibular teeth. Unfortunately, when headgear is utilized, the patient's teeth often tip instead of moving bodily. To overcome this undesired movement, doctors often use a combination of extraoral and intraoral devices and mechanics to achieve the desired motion or movement of particular malpositioned teeth.

Despite the effectiveness of these known appliances in moving posterior teeth, they can often produce less than ideal results. Other types of orthodontic devices for correcting the relative position of the teeth of a dental arch are also known in the field. Unfortunately, it is difficult to move teeth with these devices because reciprocal forces can cause undesirable tooth movement. Therefore, implants, commonly known as temporary anchorage devices, have recently been used to eliminate the reciprocal forces. However, current implant-based devices necessarily require extensive lab time for fabrication of the appliances. Each device must be custom fabricated for the particular patient and application. Still other implants do not allow the fabrication of appliances at all. Therefore, it would be advantageous to provide an adjustable auxiliary device effective for moving posterior teeth such as molars in movements such as extrusion, intrusion, retraction, protraction, and/or distalization that is simple to use and install and allows for multiple exertion members to be simultaneously attached. The present invention disclosed below meets and surpasses such needs with one simple device.

### SUMMARY OF THE INVENTION

The following description and the annexed drawings set forth in detail certain illustrative embodiments of the invention. These embodiments are indicative of but a few of the various ways in which the principles of the invention may be employed. There has thus been outlined, rather broadly, features of the invention in order that the detailed description thereof that follows may be better understood, and in order that the present contribution to the art may be better appreciated.

The present invention discloses an auxiliary force exertion device for anchoring to a patient's principal maxillary or mandibular bone by use of temporary anchorage devices, or other suitable means, for applying corrective forces for intrusion, extrusion, retraction, protraction, and/or distalization movement positioning to at least malpositioned first and/or second molars, or other malpositioned teeth.

Embodiments of the auxiliary device comprise a prefabricated length-adjustable configuration comprising a rod having a first anchor attachment portion proximate to an end of a rod and a separate tube having a second anchor attachment portion proximate to an end of the tube.

It should be understood that any one of the features of the invention may be used separately or in combination with other features. It should be understood that features which have not been mentioned herein may be used in combination with one or more of the features mentioned herein. Other systems, methods, features, and advantages of the present invention will be or become apparent to one with skill in the art upon examination of the drawings and detailed description. It is intended that all such additional systems, methods, features, and advantages be included within this description, be within the scope of the present invention, and be protected by the accompanying claims.

### BRIEF DESCRIPTION OF THE SEVERAL VIEWS OF DRAWINGS

The foregoing summary as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

FIG. 1 depicts a front view of an adjustable auxiliary device for applying intrusive corrective forces to teeth according to the present invention;

FIG. 2 depicts a front view of the adjustable auxiliary device of FIG. 1 when taken apart into two sections according to the present invention;

FIG. 3 depicts a side view of the body of a threaded anchorage implant with attachment ball and further depicting a cut-away view of an abutment component cap locked in an attached position with the attachment ball for use with and according to one embodiment of the present invention;

FIG. 4 depicts a front view of the device of FIGS. 1 and 2 anchored by the anchorage device of FIG. 3 when surgically positioned and connected for intrusive force application to teeth according to the present invention;

FIG. 5 depicts a front view of another embodiment of an adjustable auxiliary device according to the present invention in an operational arrangement for applying intrusive and/or extrusive corrective forces to malpositioned teeth;

FIG. 6 depicts a front view of an embodiment of an adjustable auxiliary device for applying corrective forces to malpositioned teeth in at least an anteroposterior fashion; and,

FIG. 7 depicts a front view of an alternate embodiment of the device in FIG. 6 having at least one articulable attachment member for applying corrective forces to malpositioned teeth in an anteroposterior and/or rotative fashion as desired according to the present invention.

FIG. 7A depicts a view of a rod and first anchor attachment portion as shown in FIG. 7 in a detached and rotated position.

### DETAILED DESCRIPTION OF THE INVENTION

The following discussion is presented to enable a person skilled in the art to make and use the invention. The general principles described herein may be applied to embodiments and applications other than those detailed herein without departing from the spirit and scope of the present invention as defined by the appended claims. Therefore, the present invention is not intended to be limited to the embodiments shown, but is to be accorded the widest scope consistent with the principles and features disclosed herein.

As an introduction to the present invention, the context of the following discussion is primarily one in which reference is made to various embodiments of an auxiliary device anchored to a patient's principal maxillary bone by use of a temporary anchorage device that is utilized for applying corrective extrusive, intrusive, retractive, protractive, and/or distalization forces and movement positioning to malpositioned teeth, such as the depicted first and second molars.

Furthermore, the present invention is directed toward prefabricated appliance components that may be assembled shortly before use, allowing assembly while the patient is in the chair. Therefore, the disclosed implant and orthodontic appliances may be connected without the necessity of lab time while still facilitating a variety of tooth movements. Embodiments of the disclosed invention also provide a spring loaded rod and piston molar distalizer, a rod and piston reversibly attachable intruder, a rod and piston reversibly attachable extruder, and a rod and piston reversibly attachable mandibular advancer.

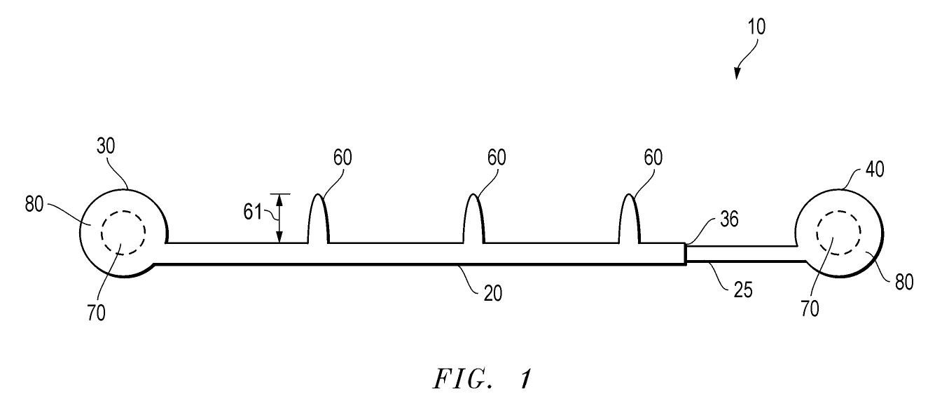

Referring now to the drawings and initially to FIGS. 1, 2, and 4, an adjustable auxiliary device 10 for applying intrusive corrective forces to teeth is disclosed as contemplated by the present invention. The intrusive auxiliary device 10 comprises a two-piece prefabricated configuration constructed from materials including, but not limited to, stainless steel, titanium, titanium alloy, NiTi alloy, rubber, plastic, nylon, or carbon fiber, with stainless steel being the preferred material. Specifically, the length-adjustable two-piece configuration comprises a rod 25 having a first anchor attachment portion 40 proximate to an end of the rod 25 and a separate tube 20 having a second anchor attachment portion 30 proximate to an end of the tube 20. In this embodiment, the first anchor attachment portion 40 and the second anchor attachment portion 30 both comprise an integrally attached component cap 80 for removable attachment to an implant 70.

The component cap 80 and implant 70 are more clearly depicted in FIG. 3, wherein a cross-sectional view of the component cap 80 is shown being attached onto the implant 70. The threaded anchorage implant 70 and component cap 80 are known in the art and are commercially available from IMTEC Corporation of Ardmore, Okla., and marketed under product numbers IMTECORTH6, IMTECORTH8, IMTECORTH10. The threaded anchorage implants may be manufactured from TiAl6V4 titanium alloy with cap number MH4 manufactured from stainless steel.

However, a person having ordinary skill in the art would instantly recognize that the present invention is not limited to the anchorage/attachment combination disclosed herein. Other types of anchorage devices and complementary attachment portions may be utilized with only minimal effort and are fully contemplated by the present invention. Therefore, the present invention contemplates the use of all accommodating future implant devices for use with the present invention.

With further reference to FIGS. 1, 2 and 4, it is shown that the tube 20 of the present invention comprises a substantially hollow cavity throughout the longitudinal body portion of the tube 20. To enable the rod 25 and tube 20 to be slidably adjustable in overall length when mated together, the rod 25 and tube 20 are designed with particular diameters to enable proper operation. Specifically, the rod 25 should have an outer diameter that is slightly smaller than the inner diameter of the tube 20, enabling the slidable engagement as described herein. In a preferred embodiment, an internal cavity 36 of the tube 20 may have an inner diameter of approximately 0.040 inches with the rod 25 having an outer diameter in the range of about 0.038 to 0.039 inches.

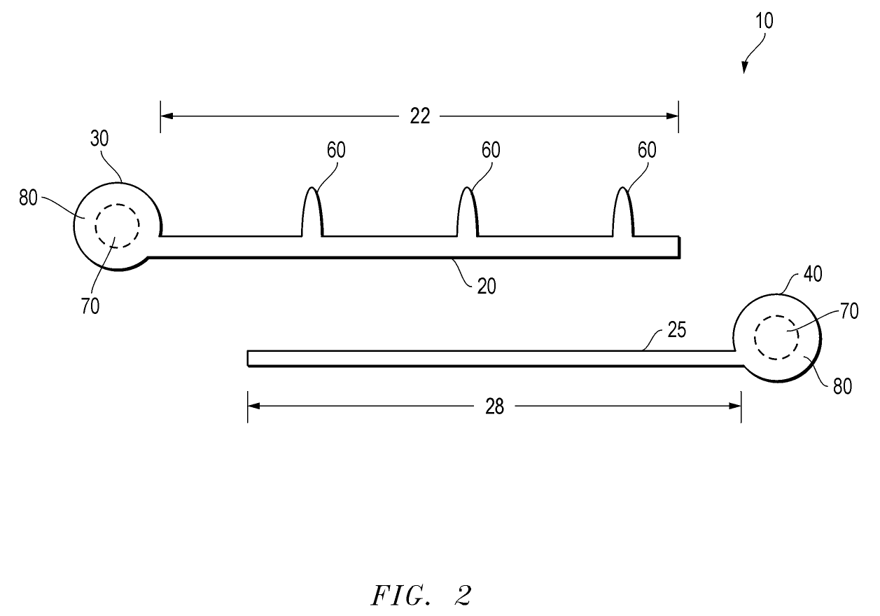

FIG. 2 depicts the intrusive auxiliary device 10 where the rod 25 and tube 20 are separated, or disengaged from one another. As shown, the tube 20 has a length 22 that may range from about 5 mm to about 50 mm. Similarly, the rod 25 has a length 28 that may range from about 5 mm to about 50 mm. Preferably, the length 22 of the tube 20 and the length 28 of the rod 25 are about 25 mm each. However, one skilled in the art will understand that the lengths 22, 28 of the tube 20 and the rod 25, respectively, may be of essentially any desired length. More importantly, it should be recognized that the tube 20 and the rod 25 may be cut to the desired length shortly before placement into a patient's mouth with simple tools.

As shown in the embodiment of the device 10 of FIGS. 1, 2 and 4 the tube 20 comprises at least one, but preferably two or more, force member attachment prongs 60 extending outwardly from the tube 20. When configured on the tube 20 each force member attachment prong 60 extends upwardly above the surface of the tube 20 a particular height 61 of approximately 3 mm. One skilled in the art will understand that the force member attachment prongs 60 may be of taller or shorter heights, can be of differing sizes and types, and can also differ in shape from those depicted in FIGS. 1, 2, and 4 without diverging from the spirit of the present invention.

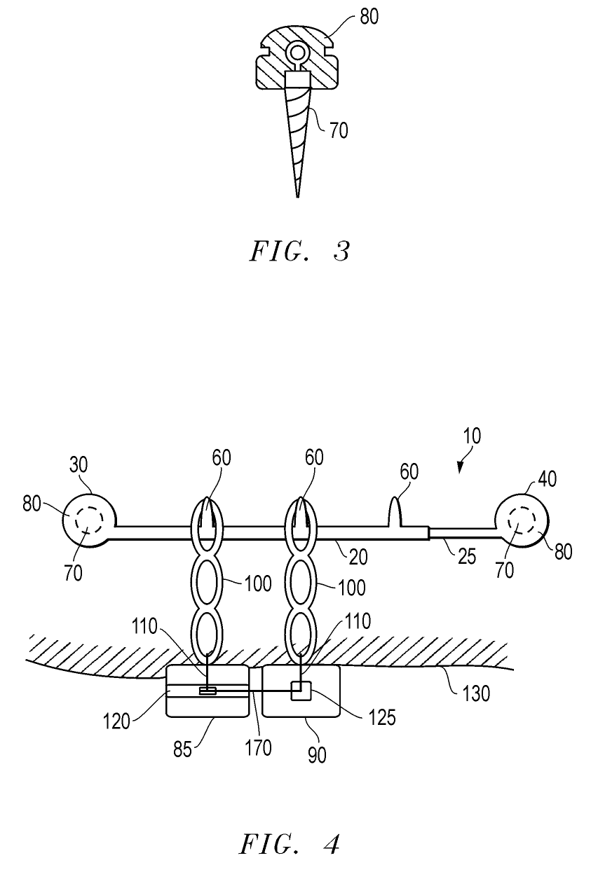

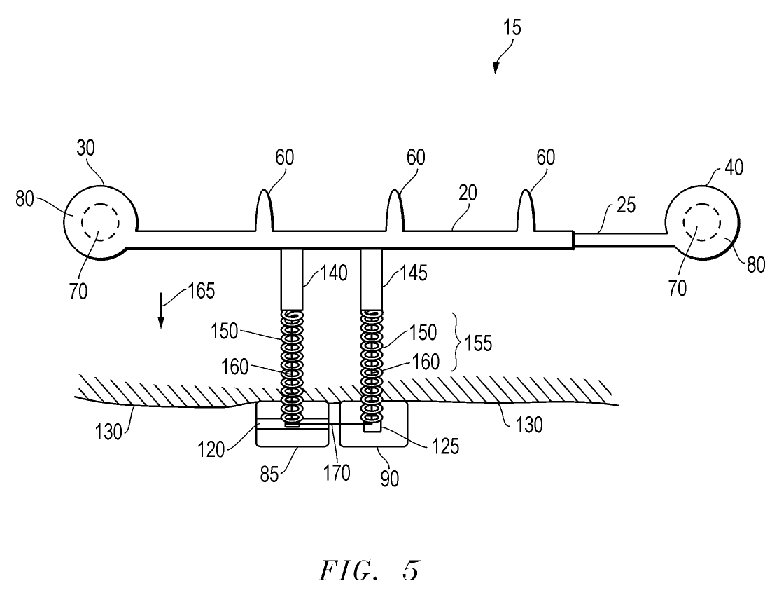

With specific reference now to FIG. 4 an adjustable auxiliary device 10 is depicted for applying intrusive corrective forces to teeth in a clinically installed operational configuration within a portion of the patient's mouth. In particular, it is preferable for the adjustable auxiliary device 10 is be installed into the maxillary bone 130, but the adjustable auxiliary device 10 is not solely limited to that particular use. It can be readily seen in FIG. 4 how the auxiliary device 10 is mounted to the maxillary bone 130 at both the first anchor attachment portion 40 and the second anchor attachment portion 40 through the use of a threaded implant 70 (not visible) and component cap 80 combination as depicted in the elevation view of FIG. 3. When positioned and mounted in the patient's mouth, as depicted, force retraction members 100 are attached to particular force member attachment prongs 60 for providing intrusive movement of one or more of the patient's malpositioned teeth. The embodiment shown in FIG. 4 depicts force retraction members 100 being specifically attached to a patient's first molar 90 and second molar 85. It will be understood by one skilled in the art that the force retraction member 100 is not limited to elastics, as depicted in FIG. 4. In fact, the present invention contemplates all present and future mechanisms and apparatus that may be appropriately incorporated into embodiments of the present invention to provide the desired intrusive and/or extrusive forces.

To accommodate attachment of the force retraction member 100 to a particular tooth, such as the depicted first molar 90 or second molar 85, a device such as a metal band 120 or metal bracket 125 may be utilized. For the embodiment depicted in FIG. 4, a metal band 120 is utilized in conjunction with the second molar 85, while a metal bracket 125 is utilized for the first molar 90. However, one skilled in the art will understand that the metal band 120 or metal bracket 125 may be interchangeably used with any particular tooth, including the depicted molars 85, 90, without departing from the scope and spirit of the present invention. Regardless of which device is utilized, either the metal band 120 or metal bracket 125, any suitable means may be used to secure the device onto the tooth, such as through the use of a dental adhesive. Furthermore, each metal band 120 or metal bracket 125 may also be provided with a hook projection member 110 which will facilitate securing the force retraction member 100 to the metal band 120 or metal bracket 125.

To permit and encourage corresponding intrusive movement of two or more teeth when coupled to the adjustable auxiliary device 10, a removable, semi-rigid archwire 170 may be interposed and connected between two teeth, as shown between metal band 120 of the first molar 90 and metal bracket 125 of the second molar 85. The archwire 170 may facilitate the desired tooth movement by moving the two or more teeth in parallel.

Using the disclosed methods and apparatus, embodiments of the present invention may be utilized to provide intrusion of as little as 1 mm or 2 mm up to a maximum of 20 mm to 25 mm. However, an average intrusion of approximately 3 mm to 6 mm is anticipated to be the most commonly desired displacement to correct a malpositioned tooth, such as first molar 90 or second molar 85.

In operation the adjustable auxiliary device 10 may be generally installed in a series of basic, common steps. First, one or more implants 70 are surgically placed in the maxillary jaw bone 130 superior and in close proximity to the teeth to be intruded. The prefabricated components, the tube 20 and the rod 25, are individually placed onto the corresponding implants 70. In the depicted embodiments, the integral component caps 80 are secured onto the respective implants 70, but other means of securing the components onto the implants 70 are contemplated. The tube 20 and rod 25 are aligned to be in close proximity and generally parallel to one another. This arrangement allows the tube 20 and rod 25 to be individually marked with respect to the complementary part. Thus, both the tube 20 and the rod 25 may be marked to allow each component to be cut short of the opposite implant 70 by approximately 3 mm. The cutting of the tube 20 and the rod 25 may be done before or after removal of the two components from their respective implants 70. After removal and cutting, the prefabricated components, tube 20 and rod 25, may be assembled by inserting the rod 25 into the tube 20 to form the adjustable auxiliary device 10. Thereafter, the assembled adjustable auxiliary device 10 may be reversably coupled, as a unit, to the two implants 70. After installation of the adjustable auxiliary device 10, force retraction members 100 may be placed in position between a force attachment prong 60 of the adjustable auxiliary device 10 and the hook projection member 110 of a metal band 120 or metal bracket 125 secured on particular tooth, such as a first molar 90 or second molar 85.

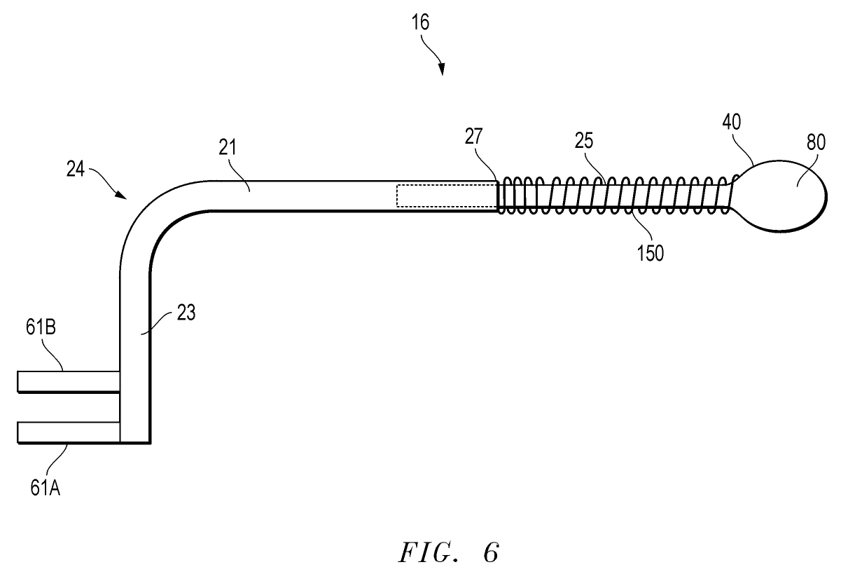

Now turning to FIG. 5, another embodiment of the present invention is depicted in operation placement with a patient's maxillary bone 130. The embodiment depicted is a combination intrusive/extrusive auxiliary device 15 for additionally providing an extrusive movement of at least one tooth, such as, for example, first molar 90 or second molar 85. The extrusive auxiliary device 15 comprises essentially the same tube 20 and rod 25 as the adjustable auxiliary device 10 of FIGS. 1, 2, and 4. Furthermore, as with the adjustable auxiliary device 10, any suitable means may be utilized for securing the device 15 onto a pair of implants 70. It is contemplated by the present disclosure that alternate embodiments can be adapted to accommodate attachments to any number of teeth or implants without departing from the scope of the invention. Therefore, the depicted device may utilize a first anchor attachment portion 40 and a second anchor attachment portion 30 utilizing any known methods or structures to secure the device to the implants 70.

The primary difference between the combination intrusive/extrusive auxiliary device 15 may further comprise one or more sleeves, such as the depicted first sleeve 140 and second sleeve 145 of FIG. 5. Each sleeve is generally affixed to the tube, either integrally or as a separate component, and extends away from the tube 20, such as the depicted first sleeve 140 and second sleeve 145 of FIG. 5 which extend in a perpendicular direction from the tube 20.

The first sleeve 140 and the second sleeve 145 are generally comprised from a material such as stainless steel, titanium, titanium alloy, NiTi alloy, rubber, plastic, nylon, or carbon fiber with stainless steel being the preferable material. Each sleeve 140, 145 will generally have a substantially hollow body to enclose a portion of a force application member 155. In the depicted embodiment, the force application member 155 is a coil spring 150 in combination with a metal piston 160 providing vertical translational movement when attached to one or more teeth of the patient. However, the present embodiment contemplates other vertical translational extrusive devices without departing from the scope and spirit of the present invention. As with the embodiment of FIG. 4, the force application member 155 is coupled to a metal band 120 or metal bracket 125, which may be accomplished in any suitable fashion such as attaching to a hook projection member 110 using a locking eyelet system, using a short tube that fits over a ballhook, or simply ligation of a wire.

The combination intrusive/extrusive auxiliary device 15 depicted in FIG. 5 provides and exerts a downward extrusive movement force (shown by arrow 165 in FIG. 5) on one or more teeth. Optionally, the device 15 may utilize a removable semi-rigid archwire 170 interposed and connected between two teeth, such as between the metal bracket 125 of the first molar 90 and the metal band 120 of the second molar 85 to ensure corresponding tooth movement.

Using the methods and apparatus disclosed with reference to FIG. 5, embodiments of the present invention may be utilized to provide extrusive movement of as little as 1 mm or 2 mm up to a maximum of 20 mm to 25 mm. However, an average extrusion of approximately 3 mm to 6 mm is anticipated to be the most commonly desired displacement to correct a malpositioned tooth, such as first molar 90 or second molar 85.

As with the adjustable auxiliary device 10 of earlier figures, combination intrusive/extrusive auxiliary device 15 depicted in FIG. 5 may be installed in a series of simple steps. First, one or more implants 70 are surgically placed in the maxillary jaw bone 130 superior and in close proximity to the teeth to be intruded. The prefabricated components, the tube 20 and the rod 25, are individually placed onto the corresponding implants 70. In the depicted embodiments, the integral component caps 80 are secured onto the respective implants 70, but other means of securing the components onto the implants 70 are contemplated. The tube 20 and rod 25 are aligned to be in close proximity and generally parallel to one another. This arrangement allows the tube 20 and rod 25 to be individually marked with respect to the complementary party. Thus, both the tube 20 and the rod 25 may be marked to allow each component to be cut short of the opposite implant 70 by approximately 3 mm. The cutting of the tube 20 and the rod 25 may be done before or after removal of the two components from their respective implants 70. After removal and cutting, the prefabricated components, tube 20 and rod 25, may be assembled by inserting the rod 25 into the tube 20 to form the combination intrusive/extrusive auxiliary device 15. Thereafter, the assembled adjustable auxiliary device 15 may be reversably coupled, as a unit, to the two implants 70.

After installation of the combination intrusive/extrusive auxiliary device 15, the force application member 155 may be placed into the first sleeve 140 and second sleeve 145. For the depicted force application member 155, a combination of a coil spring 150 and a metal piston 160, the force application member 155 is placed into the respective sleeve 140, 145 and compressed superiorly and reversibly attached to the particular tooth. In particular, this is accomplished in the depicted embodiment of FIG. 5 with a metal bracket 125 attached to the first molar 90 and a metal band 120 on the second molar 85. The reversible attachment can be accomplished through ligation or other suitable means to hook projection members 110 of the molar band 120 or metal bracket 125.

Although not depicted in the appended figures, it is contemplated that in certain instances, a single combination intrusive/extrusive auxiliary device 15 may be utilized to provide intrusive forces to one particular tooth while providing extrusive forces to another tooth. A person having ordinary skill in the art would instantly recognize that this may be accomplished by providing a single sleeve, such as first sleeve 145, and force application member 155 for providing extrusive forces to the second molar 85. At the same time a force retraction member 100 may be coupled to the first molar 90, as in FIG. 4. With such a configuration, intrusive and extrusive forces can be simultaneously applied to different teeth of the patient. Obviously, a person having ordinary skill in the art would recognize the numerous modified configurations that may be used to accomplish one or more objectives of the present invention.

Now turning to FIG. 6, yet another embodiment of the invention is depicted. In FIG. 6, an anteroposterior force adjustable device 16 is depicted. This embodiment provides anteroposteriorly applied corrective forces to malpositioned teeth. Specifically, the anteroposterior force adjustable device 16 comprises a first anchor attachment portion 40 which may be of any suitable style to secure to an implant 70 (not depicted) such as a component cap 80 described more fully with respect to FIGS. 1-4. The component cap 80 may be integrally connected to a rod 25. The component cap 80 utilized permits removable and adjustable connection to the implant 70, as shown in FIG. 3. One skilled in the art will understand that the first anchor attachment portion 40 is not limited to any particular type, style, or design.

As further shown in FIG. 6, the rod 25 is designed to be slidably engageable with a tubular conduit 21. The tubular conduit 21 is similar to the tube 20 of FIGS. 1-5, but has a non-linear configuration as described below. The tubular conduit 21 receives the rod 25 for exerting a posterior force when used in conjunction with the force application member 155 which may consist of a coil spring 150 interposed between the first anchor attachment portion 40 and the receiving end 27 of the tubular conduit 21.

The tubular conduit 21 has an approximate 90-degree bend 24. Therefore, an extension arm 23 is defined by the tubular conduit 21. In particular, the extension arm 23 extends away from the 90-degree bend 24. The distal end of the extension arm 23 is provided with at least one, and preferably two tooth interface pins 61A and 61B.

The 90-degree bend 24 allows the anteroposterior force adjustable device 16 to be maintained in a generally horizontal position when clinically installed. This permits the maximum posterior forces to be applied to one or more teeth attached to the device 16. In operation, the pins 61A and 61B are interfaced with the tooth requiring posterior movement by inserting or attaching the pins 61A and 61B to a metal band 120 or metal bracket 125 as depicted in FIGS. 4 and 5. As with the earlier embodiments, one skilled in the art will understand that any type, style, or design of band or bracket or other attachable device can be utilized with the pins 61A and 61B of the depicted embodiment without departing from the scope and spirit thereof.

Upon insertion of an implant 70 into the maxillary bone 130, or other desired location of the patient, the orthodontist may attach the component cap 80 to the implant 70 and insert pins 61A and 61B into a metal band 120 or metal bracket 125. As a result, over time, the force exerted by the force application member 150 against the cylindrical conduit 21 causes a generally posterior movement of the attached teeth. The depicted embodiment contemplates a range of posterior displacement ranging from as little as 1 mm up to a maximum of 50 mm with an average displacement of 7 mm.

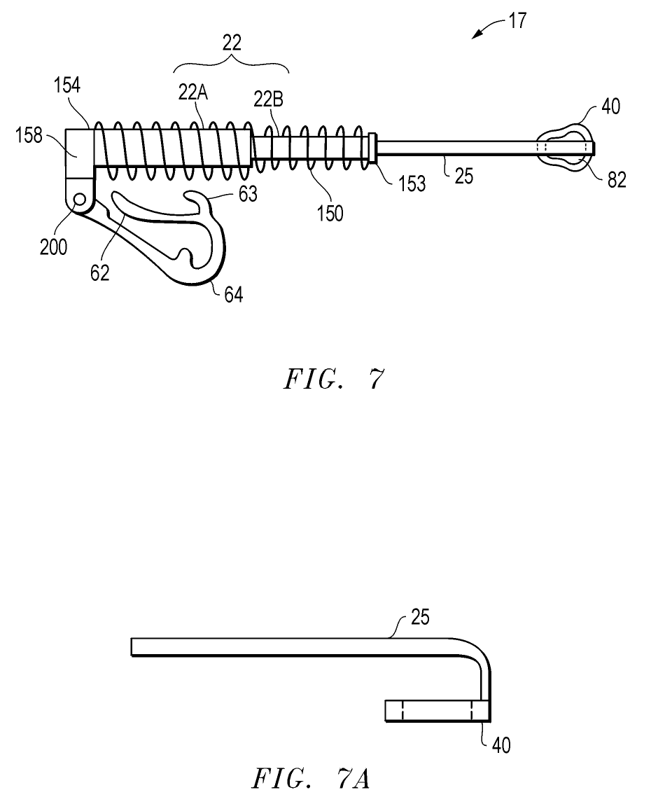

Now turning to FIG. 7, a front view of an adjustable and articulable auxiliary device 17 is described. This device 17 is another alternate embodiment of the device described and shown in FIG. 6. The adjustable and articulable auxiliary device 17 shown in FIG. 7, provides for posterior corrective forces, but also comprises at least one articulable attachment member for simultaneously applying corrective forces to malpositioned teeth in a both a posterior and rotative corrective fashion.

Specifically, adjustable and articulable auxiliary device 17 comprises a first anchor attachment portion 40 at one end of a rod 25. In this particular embodiment, the first anchor attachment portion is embodied in a key-hole configuration 82. In particular, the larger opening of the key-hole configuration 82 enables the upper ball of an implant 70 (depicted in FIG. 3) to be inserted through the key-hole configuration 82. After the ball of the implant 70 is through the key-hole configuration 82, the first anchor attachment portion 40 is slid to the right to secure the smaller portion of the key-hole configuration 82 to lock onto the implant 70. One skilled in the art will understand that the first anchor attachment portion 40 can take on numerous different styles and types, and the depicted configurations are not meant to be limiting in any manner. The present invention contemplates current and future devices that enable adjustable and removable connection of the adjustable and articulable auxiliary device 17 without departing from the scope and spirit of the invention. For clarity of the design of the rod 25 used in the present embodiment, FIG. 7A depicts a view of the rod 25 and first anchor attachment portion 40 detached from sheath member 22A and in a rotated position.

As further shown in FIG. 7, the rod 25 is designed so as to slidably engage with a cooperating assembly 22. The cooperating assembly 22 comprises a generally cylindrically shaped channel therein. The cooperating assembly 22 depicted comprises a sheath member 22A and a sheath piston member 22B. The sheath member 22A and the sheath piston member 22B of the cooperating assembly 22 permit reception of the rod 25 for exerting at least a posterior force. In particular, when a force application member such as the depicted coil spring 150 is provided, the cooperating assembly may provide a posterior force. The depicted force application member 150 exerts force at one end on a retaining washer 153 and at the other end on the end 154 of the cooperating assembly 22.

The cooperating assembly 22 further comprises an articulable hook device 64 hingeably engaged by hinge joint 200 with an end abutment device 158. The articulable hook device 64 comprises at least one, preferably two, tooth coupling tabs 62 and 63. The coupling tabs 62 and 63 are integrally designed as part of the articulable hook device 64 and extend away from the articulable hook device 64 in generally arcuate bifurcations and extend in a direction that is substantially opposite in direction as the first anchor attachment portion 40. It is also contemplated that the present invention may utilize a transverse hinge to provide for additional configuration options. In view of the present disclosure, a person having ordinary skill in the art would instantly appreciate the advantages provided by a transverse hinge. Therefore, it is within the scope and spirit of the present invention to use such hinges.

In operation, the tooth coupling tabs 62 and 63 are interfaced with the tooth requiring posterior and/or rotational movement by inserting or attaching the tabs 62 and 63 to a metal band 120 or metal bracket 125 on a patient's tooth, as described with respect to other embodiments. The metal band 120 and metal bracket 125 described are similar to the types utilized in the previous embodiments. However, one skilled in the art will understand that any type, style, or design of band or bracket or other attachable device can be utilized with the tabs 62 and 63 of the present invention without departing from the scope and spirit thereof.

Upon insertion of the implant 70 into the maxillary bone 130, or other desired location of the patient, the orthodontist simply attaches cap 80 of the adjustable and articulable auxiliary device 17 to the implant 70 and inserts tabs 62 and 63 into the metal band 120 or metal bracket 125 as desired. As a result, over time, the force exerted by the force application member 150 against the end 154 of the cooperating assembly 22 causes a generally posterior and/or rotational movement of the attached teeth. The present invention contemplates posterior displacement in the range of approximately 1 mm to approximately 50 mm with an expected average displacement of approximately 7 mm.

The above disclosure provides for adjustable auxiliary devise for exerting extrusive, intrusive, retractive, protracive, and/or distalization forces upon malpositioned molars or other teeth. Such specific design that provides adjustable custom fitting and movement forces is not available in today's market. The present invention meets that need and contemplates future technological advancements that allow other improvements and functionality thereto. In addition, although the present invention is described in connection and use orthodontic dentistry, the inventor of the present invention contemplates that such applications are unlimited and are covered by the present disclosure.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (devices, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention.

What is claimed is:

1. An adjustable appliance for exerting corrective forces to malpositioned teeth, the appliance comprising:
a rod member, the rod member having a first anchor attachment portion for securing to an implant,
a substantially hollow tubular member defining an inner cavity,
the rod member being slidably engaged with the substantially hollow tubular member, and
a first force member coupled with the substantially hollow tubular member and at least one tooth of a patient.

2. The appliance of claim 1, wherein the force member exerts one or more forces selected from the group consisting of: extrusive, intrusive, retractive, protractive, and distalization forces.

3. The appliance of claim 1, wherein the rod member and the substantially hollow tubular member are co-axial, and wherein a portion of the rod member is located within the inner cavity of the substantially hollow tubular member.

4. The appliance of claim 1, further comprising:
at least one force attachment prong extending outwardly from the tubular member, wherein the force member is coupled

5. The appliance of claim 1, further comprising:
the rod comprising a material and having a thickness that may be cut with a hand tool.

6. The appliance of claim 1, further comprising:
a second anchor attachment portion fixedly coupled with the substantially hollow tubular member.

7. The appliance of claim 1, wherein the force member comprises:
a force application member

8. The appliance of claim 7, wherein the force application member comprises:
a coil spring

9. The appliance of claim 8, wherein the force application member further comprises:
a piston being operatively coupled with the coil spring.

10. The appliance of claim 1, wherein the force member comprises:
a force retention member.

11. The appliance of claim 10, wherein the force retention member comprises:
an elastic retention band.

12. The appliance of claim 1, wherein the first anchor attachment portion is located at a distal end of the rod member.

13. The appliance of claim 6, wherein the second anchor attachment portion is located at a distal end of the substantially hollow tubular member.

14. The appliance of claim 1, wherein the substantially hollow tubular member further comprises:
an approximately ninety-degree bend, the distal portion of the substantially hollow tubular member defines an extension arm, and
wherein the appliance further comprises at least one tooth interface pin extending outwardly from the extension arm.

15. The appliance of claim 1, further comprising:
an articulable hook device hingeably engaged with the substantially hollow tubular member.

16. The appliance of claim 15, wherein the articulable hook device is hingeably engaged with a transverse hinge.

17. A method for exerting corrective forces to malpositioned teeth, comprising the steps of:
providing an appliance comprised of a substantially hollow tubular member and a rod member,
anchoring the appliance to a first implant secured into a maxillary bone of a patient,
coupling at least one force member between the appliance and a tooth of the patient.

18. The method of claim 17, wherein the force member comprises a force retraction member.

19. The method of claim 17, wherein the force member comprises a force application member.

20. The method of claim 17, further comprising the step of:
anchoring the appliance to a second implant secured into the maxillary bone of the patient.
